(19) United States
(12) Patent Application Publication
(10) Pub. No.: US 2006/0149527 A1
(43) Pub. Date: Jul. 6, 2006

(54) System and method to determine peak power demand in an integrated circuit

(76) Inventor: Thomas R. Toms, Dripping Springs, TX (US)

Correspondence Address: QUALCOMM, INC, 5775 MOREHOUSE DR., SAN DIEGO, CA, 92121, US

(21) Appl. No.: 11/180,441

(22) Filed: Jul. 13, 2005

Related U.S. Application Data
(60) Provisional application No. 60/634,960, filed on Dec. 9, 2004.

(51) Int. Cl. G06F 17/50

(52) U.S. Cl. 703/18; 361/62

(57) ABSTRACT

A method comprises receiving a description of a power distribution network of a circuit, defining at least one DC supernode in the power distribution network, receiving a logical description of the circuit, and determining at least one logic path in the circuit. The method further comprises traversing the at least one logic path in reverse and determining at least one input vector of the at least one logic path. The input vector describes a plurality of nodes in the logic path and a logic transition at an output node occurring in response to a combination of logic transitions at at least one input node in the at least one logic path. The method further comprises assigning a weighting value-to each logic transition of each node in the at least one input vector, identifying at least one input vector with maximum contribution to drawing power from the power distribution network as indicated by the assigned weighting, and simulating an AC response of the identified at least one input vector with maximum contribution and identifying at least one logic path generating a peak load to the power distribution network.

### RELATED APPLICATION

This patent application claims the benefit of Provisional Patent Application No. 60/634,960 filed on Dec. 8, 2004.

### BACKGROUND

In an integrated circuit, the power distribution network delivers currents to all the components in the circuit. The power distribution network may span multiple metal layers in the integrated circuit and may be laid out in a three-dimensional grid pattern. With the higher device densities and faster switching frequencies of today's integrated circuits, especially microprocessors, it is vital to validate the power distribution network design. Today's high performance microprocessors such as digital signal processors place even more demands on the power supply along with imposing much tighter tolerance requirements. These digital signal processors are being designed with lower voltage requirements in order to reduce overall power dissipation. The lower voltages require a power distribution network that is capable of delivering much higher currents. Therefore, it is important to perform accurate simulations of the integrated circuit design to detect AC current bottlenecks. An AC current bottleneck occurs when the impedance of the power distribution network is too high to enable sufficient current flow to meet local device current demands. As a result of AC current bottlenecks, the performance and speed of the integrated circuit may be drastically degraded.

### SUMMARY

In one embodiment of the disclosure, a method comprises receiving a description of a power distribution network of a circuit, defining at least one DC supernode in the power distribution network, receiving a logical description of the circuit, and determining at least one logic path in the circuit. The method further comprises traversing the at least one logic path in reverse and determining at least one input vector of the at least one logic path. The input vector describes a plurality of nodes in the logic path and a logic transition at an output node occurring in response to a combination of logic transitions at at least one input node in the at least one logic path. The method further comprises assigning a weighting value to each logic transition of each node in the at least one input vector, identifying at least one input vector with maximum contribution to drawing power from the power distribution network as indicated by the assigned weighting, and simulating an AC response of the identified at least one input vector with maximum contribution and identifying at least one logic path generating a peak load to the power distribution network.

In another embodiment of the disclosure, a method of generating a set of vectors for simulation of a circuit comprises receiving a logical description of the circuit, determining at least one logic path in the circuit, and traversing the at least one logic path in reverse and determining at least one input vector of the at least one logic path. The input vector describes the nodes in the logic path and a logic transition at an output node occurring in response to a combination of logic transitions at at least one input node. The method further comprises assigning a weighting value to each transition of each node in the at least one input vector, the weighting value being assigned in consideration of, at least in part, dynamic load, transition timing, and impedance of the power distribution network at the node, and identifying at least one input vector with maximum contribution to drawing power from the power distribution network as indicated by the assigned weighting.

In yet another embodiment of the disclosure, a computer-readable medium having encoded thereon a method comprises receiving a description of a power distribution network of a circuit, defining at least one DC supernode in the power distribution network, receiving a logical description of the circuit, and determining at least one logic path in the circuit. The method further comprises traversing the at least one logic path in reverse and determining a plurality of input vectors of the at least one logic path, where the input vectors each describes a plurality of nodes in the logic path and a logic transition at an output node occurring in response to a combination of logic transitions at at least one input node in the at least one logic path. The method further comprises assigning a weighting value to each logic transition of each node in each input vector, the weighting value being assigned in consideration of, at least in part, dynamic load, transition timing, and impedance of the power distribution network at the node, and identifying a plurality of input vectors with maximum contribution to drawing power from the power distribution network. The method further comprises combining the identified plurality of input vectors for simulation, and simulating an AC response of the identified plurality of input vectors with maximum contribution and identifying at least one logic path generating a peak load to the power distribution network.

A system comprises means for receiving a description of a power distribution network and a logical description of a circuit, means for defining at least one DC supernode in the power distribution network, and means for determining at least one logic path in the circuit. The system further comprises means for traversing the at least one logic path in reverse and determining at least one input vector of the at least one logic path, wherein the input vector describes a plurality of nodes in the logic path and a logic transition at an output node occurring in response to a combination of logic transitions at at least one input node in the at least one logic path. The system further comprises means for assigning a weighting value to each logic transition of each node in the at least one input vector and identifying at least one input vector with maximum contribution to drawing power from the power distribution network as indicated by the assigned weighting, and means for simulating an AC response of the identified at least one input vector with maximum contribution and identifying at least one logic path generating a peak load to the power distribution network.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a simplified block diagram of an embodiment of a system and method to determine peak power demand in an integrated circuit;

FIG. 2 is a flowchart of an embodiment of a method to determine peak power demand in an integrated circuit;

FIG. 3 is a schematic diagram of a logic circuit used as an example to illustrate the method to determine peak power demand in an integrated circuit;

FIGS. 4-6 are schematic diagrams of a simple logic circuits used as examples to further illustrate the method to determine peak power demand in an integrated circuit; and

FIGS. 7-9 are graphical representations of DC super node definition and overlapping AC simulation windows.

### DETAILED DESCRIPTION

The system and method described herein may be used to identify AC current bottlenecks in the power distribution network of an integrated circuit. Once detected, design changes such as reducing the impedance and increasing the effective capacitance of the power distribution network may be made to improve the overall power distribution network design. The peak power demand of the circuit or the worst case estimate of the effective capacitance, effective resistance and load of the power distribution network is made in order to identify the AC current bottlenecks.

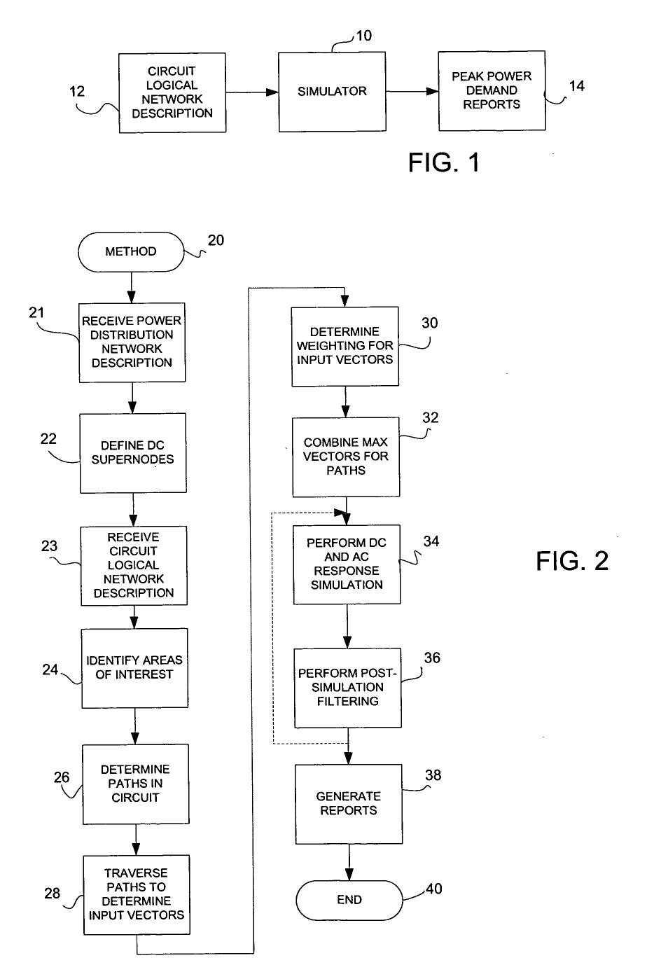

FIG. 1 is a simplified block diagram of an embodiment of a system 10 to determine peak power demand in an integrated circuit. System 10 is operable to receive one or more files 12 containing descriptions pertaining to the circuit design, such as logic design, physical layout, static timing analysis, packaging and decoupling capacitance data, etc. in known data formats or formats to be developed. System 10 is operable to perform a dynamic analysis of the power distribution network and generate output 14 such as reports and plots that identify the circuits that has the maximum demand on the power distribution network.

FIG. 2 is a simplified flowchart of an embodiment of a method 20 to determine peak power demand in an integrated circuit. The method 20 includes a first step 21, where a description of the power distribution network design and/or layout of the integrated circuit is received. The power distribution network description may be in any suitable format now known or to be developed. In step 22, one or more DC super nodes are defined or identified in the power distribution network. The power supply delivers a DC current to the circuit loads in the integrated circuit via the power distribution network. However, when individual loads are examined, the current drawn by these loads is AC-like as the loads transition between the V_{SS} and V_{CC} voltage levels. However, the more loads that are summed together, the more DC-like the cumulative load current behaves. By defining the DC super nodes as a point in the power distribution network where the sum of the currents is DC-like in behavior, the problem is split into a DC problem from the DC super nodes back to the power supply, and an AC problem from the DC super nodes to the loads on the power distribution network. The V_{CC} and V_{SS} networks are coupled together by their common capacitances and can only be separated where the desired load is effectively DC to the response. Thus, the V_{CC} and V_{SS} networks can be treated as two independent networks from the power supply to the DC super nodes. Because AC droop is a local problem where loads and capacitances at a distance have little impact on the local AC drop, one or more DC super nodes may be defined for each local area, where a local area may include 100 to 1000 logic gates or loads, for example. In general, a predetermined threshold may be set, such as 90%, so that nodes in the power distribution network where 90% of the current profile is a DC waveform are designated as DC super nodes, for example.

To determine the DC super nodes within the power distribution network, the type of load transitions that are under study should be considered. A figure of merit is the ratio of power that is DC vs. AC at the DC super node. The higher the ratio the more accurate the results and generally the larger the size of the AC problem. While the ratio can be adjusted by changing the definition of the DC super nodes to increase throughput at the cost of accuracy, it is typical to define the DC super nodes as a transition from one power distribution network layer to another. For example, the DC super nodes may be defined at the interface between the integrated circuit and the packaging. The DC super nodes may also be located at points between layers of metalization in the integrated circuit. For example, where a C4 or Controlled Collapse Chip Connection (also called flip-chip) will be used, the connection points between the integrated circuit chip and the package pads may be designated as the DC super nodes. In an integrated circuit that will use a lead frame package, the interface between the top two metal layers may be designated as the DC super nodes, for example.

In steps 23, a set of circuit logical network description 12 is received. The circuit logical network description 12 may include data pertaining to the circuit design, such as logic design, physical layout, static timing analysis, packaging and decoupling capacitance data, etc. In step 24, the areas of interest are identified in the integrated circuit. The area of interest is the localized area in the integrated circuit logic that is to be simulated to determine the peak current draw. To increase the accuracy of the simulation, a predetermined portion of circuits in areas bordering the area of interest is also analyzed and simulated. The circuits in the bordering areas may share one or more DC super nodes with circuits in the area of interest and thus may affect or contribute to the power demand of the circuit in the area of interest.

In step 26, logic paths in the area of interest and bordering areas are identified. The paths are the flow of logic from inputs to outputs in the circuit. As each time a logic gate or load switches to implement an operation it creates a dynamic load to the power distribution network. The logic switching of the path is followed to determine the load. The customary method of following logic switching is from input transitions to the new output state. However, in step 26, the logic tree is traversed backwards from the output to the input. The output switching states are traced to the input combination that would cause the change in output states. For clocked logic circuits, the paths may be further divided at the latch points in the circuit to reduce the depth of the logic tree to be traversed. The defined paths fall into one of the six categories of logic paths:
1. primary outputs to the primary inputs (through path)
2. primary outputs to latch points (output capture)
3. latch points to latch points (internal path)
4. latch points to primary inputs (input capture)
5. latch clock node to primary clock input (clock tree)
6. latch clock node to latch point (clock control)

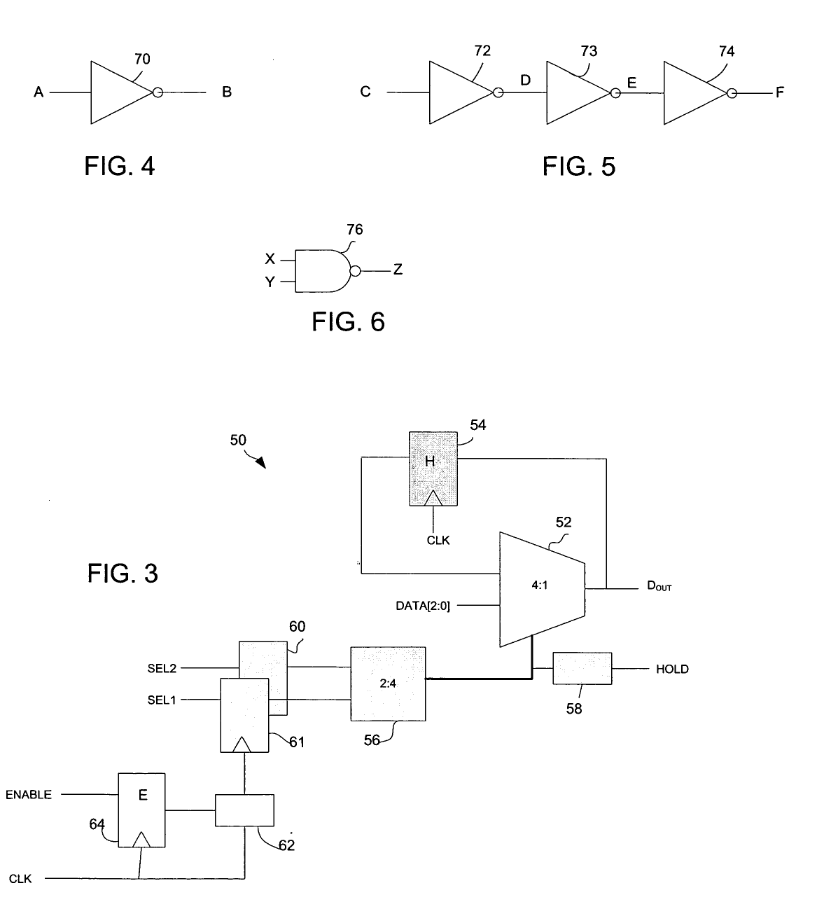

FIG. 3 is a schematic diagram of a logic circuit 50 used to illustrate the step of identifying the logic paths in the circuit. The circuit 50 generates a D_{OUT} signal from the output of a 4:1 mutiplexer 52, which receives, as its input, a latched output from a clocked H latch 54, and three data signals, Data[2:0]. The select signal inputs to the multiplexer 52 are the outputs from a 2:4 decoder 56. One of the decoder output is provided as an input to a buffer 58, which is provided as an output signal, HOLD. The input of the decoder 56 are output signals from clocked S latches 60 and 61, which receives inputs Sel2 and Sel1, respectively. The clock input of the S latches 60 and 61 are from the output of a clock buffer 62, which buffers the clock signal, CLK, with a control signal received from the output of a clocked E latch 64, with a signal, ENABLE, as its input. As shown in FIG. 3, the logic paths of the circuit are:
1. Dout<4:1 mux<H Latch
2. Dout<4:1 mux<Data[2:0]
3. Dout<4:1 mux<2:4 decode<S Latch[2:1]
4. Hold<Buffer<2:4 decode<S Latch[2:1]
5. S Latch[2:1]<Clock buffer<E Latch
6. S Latch[2:1]<Clock buffer<Clk
7. E Latch<Clk
8. E Latch<Enable
9. H Latch<Clk
   In the above listing, the logic paths sharing similar paths are not repeated for the sake of brevity.

In step 28, the logic paths are traversed to determine the input vectors for each path, and in step 30, the weighting for the input vectors are determined. As there can be more than one set of events that result in an output, the events are weighted to determine the event set that would present the peak load to the power distribution network.

As an illustrative example, an inverter 70 having input A and output B as shown in FIG. 3 would have input vectors:
Vector 1: B/>>A\
Vector 2: B\>>A/
   This notation indicates that a logic circuit consisting of an inverter would have the input vectors shown above. Vector 1 indicates that the output node B loads V_{CC} when the input node A loads V_{SS}. Conversely, Vector 2 indicates that the output node B loads V_{SS} when the input node A loads V_{CC}.

A second illustrative example as shown in FIG. 4 includes three inverters 72-74 connected in series with node C as the input to the first inverter 72, node D as the output of the first inverter 72 and the input of the second inverter 73, node E as the output of the second inverter 73 and the input of the third inverter 74, and node F as the output of the third inverter 74. Traversing the circuit in reverse, the input vectors for this simple inversion chain circuit are:
Vector 1: F/>>E\>>D/>>C\
Vector 2: F\>>E/>>D\>>C/
   For each transition at a node, there are three weight factors to consider and apply. The first weight factor is the dynamic load or the charge being drawn off the V_{CC}, expressed as C-load. The second weighting takes into account how fast the transition occurs as related to the time constant or response time of the power distribution network. This weighting is expressed as Q time=1/T-switch. The third weighting is the impedance of the power distribution network as seen from the relevant DC supernode, expressed as Z-PDN. These three weighting factors are essentially pre-AC simulation “filters” that enable the system to identify those input vectors that will be most relevant to the simulation of the circuit in the area of interest and surrounding border areas. The weighting at a “Node” for the low-to-high and high-to-low transitions may be expressed as:
WNode/=C-load*Z-PDN*Q-Time(rise)
Wnode\=C-load*Z-PDN*Q-Time(fall).

As an illustrative example, the weighting, W, for the nodes in the inverter chain (FIG. 5) are:
WF/=4, WF\=1,
WE/=2, WE\=3,
WD/=1, WD\=1,
WC/=0, WC\=0
It should be noted that the above weighting values are arbitrarily assigned in order to more clearly illustrate the concept of weighting. In this example, the node F transitioning from V_{SS} to V_{CC} is weighted a 4, and the node F transitioning from V_{CC} to V_{SS} is weighted a 1. The peak load V_{CC} may be determined by:

$$\begin{matrix}Load {V}_{CC} = MAX ( Vector 1 , Vector 2 ) \\ = MAX ( WF / + WD / , WE / + WC / ) \\ = MAX ( 4 + 1 , 2 + 0 ) \\ = 5 via Vector 1\end{matrix}$$

The peak load V_{SS} may be determined by:

$$\begin{matrix}Load {V}_{SS} = MAX ( Vector 1 , Vector 2 ) \\ = MAX ( WF \backslash + WD \backslash , WE \backslash + WC \backslash ) \\ = MAX ( 3 + 0 , 1 + 1 ) \\ = 3 via Vector 1\end{matrix}$$

Therefore, the input vector Vector 1 is the most relevant to determine the peak demand for both V_{CC} and V_{SS} for this circuit example. As a result, Vector 1 will likely be used in the simulation of the AC response of the circuit in the area of interest.

As a further illustrative example, a logic circuit having a two-input NAND gate, as shown in FIG. 5, with nodes X and Y as inputs and node Z as its output has the input vectors:
Vector 1: Z/>>O(X\, Y\)
Vector 2: Z\>>A(X/, Y/),
   This notation indicates that for the output Z to transition from V_{SS} to V_{CC}, X\ OR Y\ must occur; and for output C to transition from V_{CC} to V_{SS}, X/ AND Y/ must occur. Vector 1 can thus be further expressed as the following reverse vectors:
1. Z/>>X\, Y\
2. Z/>>X\, Y-; Y-reverse dynamic load is 0
3. Z/>>X-, Y\; X-reverse dynamic load is 0
4. Z/>>X/, Y\
5. Z/>>Y/, X\
   The notations Y- and X-mean that no transition occurs in Y and X, respectively. Reverse vectors 2 and 3 do not, by their nature, increase the dynamic load because as their inputs don't switch, these vectors don't add any dynamic power to the model. Thus, reverse vector 1 may be used in the reverse logic tree. Vector 2 of the NAND gate circuit defines the following reverse vectors:
1. Z\>>X/, Y/
2. Z\>>X/, Y-; Y-reverse dynamic load is 0
3. Z\>>X-, Y/; A-reverse dynamic load is 0
   Reverse vectors 2 and 3, by their nature, do not increase the dynamic load, thus reverse vector 1 may be used in the AC simulation.

In step 32, all the maximum input vectors for the logic paths in the area of interest and bordering areas are combined into one vector in preparation to perform one simulation run. It should be noted that each logic path may generate more than one maximum input vector when more than one input vector are weighted similarly. Further, the logic paths and their input vectors should be examined to determine whether some of the logic paths are mutually exclusive paths, where the timing of the logic paths are such that they will never switch at the same time or within a certain number of time constants of the power distribution network. If the logic paths do not switch within the same time window (which may be set to be three time constants of the power distribution network), then they are orthogonal paths rather than additive paths and should not be combined together for the simulation. Separate simulation runs should be performed in this instance.

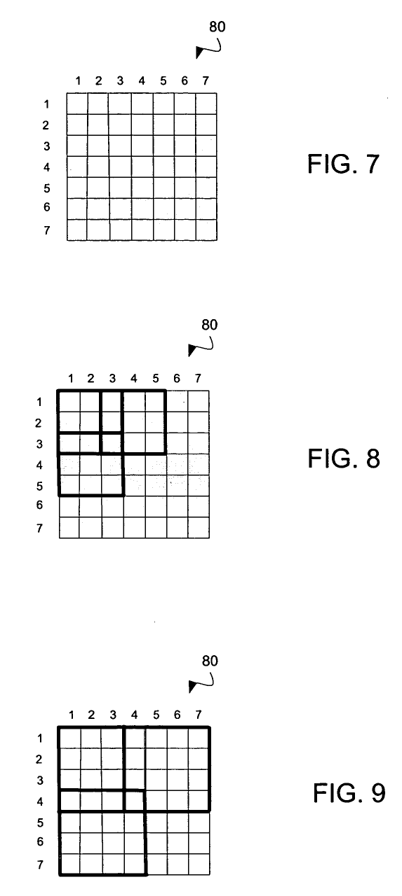

Further considerations may be given to the “window” size of the simulation. For example, in FIG. 7 a power distribution network 80 with forty-nine (49) V_{CC} and V_{SS} DC super nodes is defined. The DC super node blocks are arranged in a 7×7 matrix. It should be noted that FIG. 7 is a graphical representation with blocks of the same size and arranged in a regular manner for the purpose of demonstrating the concept and does not require the DC super nodes to be so defined in reality. The AC simulation may be run for each n×m size window, and the simulation windows may overlap. For example as shown in FIG. 8, each AC simulation window may be a 3×3 array of DC super nodes with an overlap of one (1) block. The number of runs required are nine (9) to simulate the entire chip. As shown in FIG. 9 for another example, each AC simulation window may be a 4×4 array of DC super nodes with an overlap of one (1) block. The number of runs required are four (4) to simulate the entire chip. The overlap is not restricted to one block width. For example, the same DC super nodes may be simulated with 3×3 AC simulation window with an overlap of two (2) blocks, for example. This would require twenty-five (25) simulation runs. The amount of overlap is not required to fall on block boundaries. For example, the simulation may be run with AC simulation windows of 4×4 with an overlap of 2.5 blocks, which results in nine (9) simulation runs.

It may be seen from the foregoing that the larger the simulation window and the smaller the overlap results in fewer number of simulation runs and less effort to simulate the power distribution network. Therefore, the window size should be made as large as possible with the smallest amount of overlap to provide acceptable results.

In step 34, AC simulation is performed using the maximum input vectors collected in step 32. The first time the AC simulations are performed, the windows may be centered at the mid-impedance point of the power distribution network for each DC super node. For each subsequent optional iterative AC simulation run, the simulation window boundaries may be selected or adjusted based on a weighted mathematical center of the load in the distribution network given the current profile. DC simulations are performed to determine the maximum DC droop using conventional methods. Conventional simulation tools such as SPICE, PRIMEPOWER, and REDHAWK may be used to perform the AC and DC simulations.

In step 36, certain post-simulation “filtering” may be performed. For example, a filtering may be performed to minimize the artificial edge effects of the simulation windows. The edge effects of windowing may be minimized or eliminated by “filtering” out some of the data in the overlap regions between simulation windows. For example, if the AC simulation windows are 5×5 in size, with an overlap of three (3) DC super nodes, then a portion of the overlap region is discarded. As an example, the area outside of the electrical midpoint of the overlap region for each simulation run may be discarded. In this example, a portion that is 1.5 block wide may be filtered out from the simulation result for each run. Other filter width may be used depending on the specific power distribution network.

In step 38, the system may generate data on the vector or combination of vectors in each simulation run that produced the maximum droop profile. The output may include reports, plots, and other forms of data that enables the engineering team to identify the circuit or logical path(s) that draws the maximum current from the power distribution network. A certain threshold may be set so that only those input vectors that draw more current than the threshold are identified in the report. Modifications may then be made to the circuit design in order to rectify the problem or decisions may be made to tolerate the peak droop because it falls within acceptable ranges.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims. In the claims, means-plus-function clauses are intended to cover the structures described herein as performing the recited function and not only structural equivalents, but also equivalent structures.

What is claimed is:

1. A method comprising:
receiving a description of a power distribution network of a circuit;
defining at least one DC super node in the power distribution network;
receiving a logical description of the circuit;
determining at least one logic path in the circuit;
traversing the at least one logic path in reverse and determining at least one input vector of the at least one logic path, the input vector describing a plurality of nodes in the logic path and a logic transition at an output node occurring in response to a combination of logic transitions at at least one input node in the at least one logic path;
assigning a weighting value to each logic transition of each node in the at least one input vector;
identifying at least one input vector with maximum contribution to drawing power from the power distribution network as indicated by the assigned weighting; and
simulating an AC response of the identified at least one input vector with maximum contribution and identifying at least one logic path generating a peak load to the power distribution network.

2. The method of claim 1, further comprising identifying at least one area of interest in the circuit and determining at least one logic path in the circuit within the at least one area of interest.

3. The method of claim 1, further comprising identifying areas bordering the at least one area of interest and to include the bordering area in the at least one area of interest.

4. The method of claim 1, wherein determining at least one logic path comprises determining a logic path having an output to at least one primary input.

5. The method of claim 1, wherein determining at least one logic path comprises determining a logic path having an output to at least one latch point.

6. The method of claim 1, wherein determining at least one logic path comprises determining a logic path having a latch point to at least one latch point.

7. The method of claim 1, wherein determining at least one logic path comprises determining a logic path having a latch point to at least one primary input.

8. The method of claim 1, wherein determining at least one logic path comprises determining a logic path having a latch clock node to a primary clock input.

9. The method of claim 1, wherein determining at least one logic path comprises determining a logic path having a latch clock node to a latch point.

10. The method of claim 1, wherein assigning a weighting value comprises assigning the weighting value in consideration of, at least in part, a dynamic load at the node.

11. The method of claim 1, wherein assigning a weighting value comprises assigning the weighting value in consideration of, at least in part, amount of time to make the logic transition at the node.

12. The method of claim 1, wherein assigning a weighting value comprises assigning the weighting value in consideration of, at least in part, impedance back to a DC super node of the power distribution network at the node.

13. The method of claim 1, further comprising simulating a DC response of the identified at least one input vector with maximum contribution, summing the DC response with the AC response, and identifying at least one logic path generating a peak load to the power distribution network.

14. The method of claim 1, wherein determining at least one logic path comprises determining a plurality of logic paths in the circuit, determining a plurality of input vectors for each logic path, assigning a weighting values to each logic transition of each node in the plurality of input vectors, identifying a plurality of input vectors with maximum contribution to drawing power from the power distribution network, and combining the identified plurality of input vectors for simulation.

15. The method of claim 1, further comprising defining a simulation window size and an overlapping width for the simulation.

16. The method of claim 15, further comprising processing a simulation results by filtering out data from an area outside of an electrical midpoint of the overlap width for each simulation window run.

17. A method of generating a set of vectors for simulation of a circuit, comprising:
receiving a logical description of the circuit;
determining at least one logic path in the circuit;
traversing the at least one logic path in reverse and determining at least one input vector of the at least one logic path, the input vector describing the nodes in the logic path and a logic transition at an output node occurring in response to a combination of logic transitions at at least one input node;
assigning a weighting value to each transition of each node in the at least one input vector, the weighting value being assigned in consideration of, at least in part, dynamic load, transition timing, and impedance of the power distribution network at the node; and
identifying at least one input vector with maximum contribution to drawing power from the power distribution network as indicated by the assigned weighting.

18. The method of claim 17, wherein determining at least one logic path comprises determining a plurality of logic paths in the circuit, determining a plurality of input vectors for each logic path, assigning a weighting values to each logic transition of each node in the plurality of input vectors, identifying a plurality of input vectors with maximum contribution to drawing power from the power distribution network, and combining the identified plurality of input vectors for simulation.

19. The method of claim 17, wherein determining at least one logic path comprises determining a logic path having an output to at least one latch point.

20. The method of claim 17, wherein determining at least one logic path comprises determining a logic path having a latch point to at least one latch point.

21. The method of claim 17, wherein determining at least one logic path comprises determining a logic path having a latch point to at least one primary input.

22. The method of claim 17, wherein determining at least one logic path comprises determining a logic path having a latch clock node to a primary clock input.

23. The method of claim 17, wherein determining at least one logic path comprises determining a logic path having a latch clock node to a latch point.

24. The method of claim 17, further comprising identifying at least one area of interest in the circuit and determining at least one logic path in the circuit within the at least one area of interest.

25. The method of claim 24, further comprising identifying areas bordering the at least one area of interest and to include the bordering area in the at least one area of interest.

26. A computer-readable medium having encoded thereon a method comprising:
receiving a description of a power distribution network of a circuit;
defining at least one DC supernode in the power distribution network;
receiving a logical description of the circuit;
determining at least one logic path in the circuit;
traversing the at least one logic path in reverse and determining a plurality of input vectors of the at least one logic path, the input vectors each describing a plurality of nodes in the logic path and a logic transition at an output node occurring in response to a combination of logic transitions at at least one input node in the at least one logic path;
assigning a weighting value to each logic transition of each node in each input vector, the weighting value being assigned in consideration of, at least in part, dynamic load, transition timing, and impedance of the power distribution network at the node;
identifying a plurality of input vectors with maximum contribution to drawing power from the power distribution network;
combining the identified plurality of input vectors for simulation; and
simulating an AC response of the identified plurality of input vectors with maximum contribution and identifying at least one logic path generating a peak load to the power distribution network.

27. The method of claim 26, further comprising identifying at least one area of interest in the circuit and determining at least one logic path in the circuit within the at least one area of interest.

28. The method of claim 26, further comprising identifying areas bordering the at least one area of interest and to include the bordering area in the at least one area of interest.

29. The method of claim 26, wherein determining at least one logic path comprises determining a logic path having an output to at least one primary input.

30. The method of claim 26, wherein determining at least one logic path comprises determining a logic path having an output to at least one latch point.

31. The method of claim 26, wherein determining at least one logic path comprises determining a logic path having a latch point to at least one latch point.

32. The method of claim 26, wherein determining at least one logic path comprises determining a logic path having a latch point to at least one primary input.

33. The method of claim 26, wherein determining at least one logic path comprises determining a logic path having a latch clock node to a primary clock input.

34. The method of claim 26, wherein determining at least one logic path comprises determining a logic path having a latch clock node to a latch point.

35. The method of claim 26, wherein assigning a weighting value comprises assigning the weighting value in consideration of, at least in part, a dynamic load at the node.

36. The method of claim 26, wherein assigning a weighting value comprises assigning the weighting value in consideration of, at least in part, amount of time to make the logic transition at the node.

37. The method of claim 26, wherein assigning a weighting value comprises assigning the weighting value in consideration of, at least in part, impedance back to a DC supernode of the power distribution network at the node.

38. The method of claim 26, further comprising simulating a DC response of the identified at least one input vector with maximum contribution, summing the DC response with the AC response, and identifying at least one logic path generating a peak load to the power distribution network.

39. A system comprising:
means for receiving a description of a power distribution network and a logical description of a circuit;
means for defining at least one DC supernode in the power distribution network;
means for determining at least one logic path in the circuit;
means for traversing the at least one logic path in reverse and determining at least one input vector of the at least one logic path, the input vector describing a plurality of nodes in the logic path and a logic transition at an output node occurring in response to a combination of logic transitions at at least one input node in the at least one logic path;
means for assigning a weighting value to each logic transition of each node in the at least one input vector and identifying at least one input vector with maximum contribution to drawing power from the power distribution network as indicated by the assigned weighting; and
means for simulating an AC response of the identified at least one input vector with maximum contribution and identifying at least one logic path generating a peak load to the power distribution network.

40. The system of claim 39, further comprising means for identifying at least one area of interest in the circuit and determining at least one logic path in the circuit within the at least one area of interest.

41. The system of claim 39, further comprising means for identifying areas bordering the at least one area of interest and to include the bordering area in the at least one area of interest.

42. The system of claim 40, wherein means for determining at least one logic path comprises means for determining a logic path selected from a group consisting of a logic path having an output to at least one primary input, a logic path having an output to at least one latch point, a logic path having a latch point to at least one latch point, a logic path having a latch point to at least one primary input, a logic path having a latch clock node to a primary clock input, and a logic path having a latch clock node to a latch point.

43. The system of claim 40, wherein means for assigning a weighting value comprises means for assigning the weighting value in consideration of, at least in part, a dynamic load at the node, amount of time to make the logic transition at the node, and impedance back to a DC supernode of the power distribution network at the node.

44. The system of claim 40, further comprising means for simulating a DC response of the identified at least one input vector with maximum contribution, summing the DC response with the AC response, and identifying at least one logic path generating a peak load to the power distribution network.

45. The system of claim 40, wherein means for determining at least one logic path comprises determining a plurality of logic paths in the circuit, determining a plurality of input vectors for each logic path, assigning a weighting values to each logic transition of each node in the plurality of input vectors, identifying a plurality of input vectors with maximum contribution to drawing power from the power distribution network, and combining the identified plurality of input vectors for simulation.
